(19) United States
(12) Patent Application Publication
(10) Pub. No.: US 2021/0222435 A1
(43) Pub. Date: Jul. 22, 2021

(54) Blade Assembly

(71) Applicant: Greenpolly LTD, Plymouth (GB)

(72) Inventor: David Salmon, Plymouth (GB)

(73) Assignee: Greenpolly LTD, Plymouth (GB)

(21) Appl. No.: 17/152,876

(22) Filed: Jan. 20, 2021

(30) Foreign Application Priority Data
Jan. 22, 2020 (GB) 2000935.3

(51) Int. Cl. E04D 15/00; E04D 15/02

(52) U.S. Cl. CPC E04D 15/003; E04D 15/02

(57) ABSTRACT

The invention relates to a blade assembly for a tool for removing a slate from a roof, the blade assembly comprising: a blade having a length, a width, and a plurality of teeth; and a blade support, the blade being mounted to the blade support; wherein the blade support extends over at least 30% of the width of the blade; and wherein the thickness of the blade support to a first side of the blade is greater than the set of the teeth of the blade. The invention further relates to a blade assembly for a tool for removing a slate from a roof, the blade assembly comprising: a blade having a length, a width, and a plurality of teeth; and a blade support; wherein the blade support extends over a sufficient portion of a first side of the blade such that, in use, the teeth of the blade are prevented from coming into contact with a slate adjacent the first side of the blade assembly. The blade assembly may be included in a saw, further comprising a handle.

The present invention relates to a blade assembly for a tool for use when removing a slate from a roof. More specifically, the blade assembly can be used to individually remove a single slate from a roof, without the need to remove additional adjacent slates.

It should be noted that throughout this specification, reference is made to a ‘slate’ or to ‘slates’. However, it is to be understood that devices and methods embodying the present invention are equally applicable to roofs clad in other stones, artificial slate, tiles, shingles or the like. In the interests of clarity and brevity, the term a ‘slate’, as used in this specification, is to be interpreted broadly to cover all cladding materials which are installed in a similar manner to a slate.

It should also be noted that the devices and methods embodying the present invention are not restricted to use on roofs, and may be employed to remove slates from other structures including, but not limited to, vertical walls, fences, shelters, or any structure clad functionally or decoratively in slates or similar materials. In the interests of clarity and brevity, the term ‘roof’, as used in this specification, is to be interpreted broadly to cover all surfaces clad in slates or the like.

Slate roofs protect the interior of buildings and other structures from the elements. The slates are generally supported by a frame, for example a timber frame. The frame is typically formed from a series of generally horizontal battens affixed to pitched rafters. Each slate is secured to an underlying batten using one or more fixings such as hooks, nails or the like which extend through corresponding holes in the slate. Typically these fixings are made of metal. These fixings may be formed from metals, such as steel or copper. The slates are arranged in overlapping rows such that the fixing(s) and hole(s) used to secure each slate to the roof are covered by the overlying slates of the row above to prevent the ingress of water, as will be appreciated by one of ordinary skill in the art.

Over time, the slates on a roof are subject to wear and tear. Unavoidable wear is caused by exposure to the elements, for example rain, wind, frost and sunlight. Wear or damage might also occur due to impact from falling branches, or accidental damage while performing maintenance work on the roof. This wear and tear can ultimately lead some slates, particularly those with minor defects at the point of installation, to crack or break.

This damage can be detrimental to the integrity of the roof and may result in the ingress of water. Water can then leak into the underlying structure or building where it can cause serious damage. Such damage can be difficult and costly to repair. It is therefore necessary to repair the roof by replacing damaged slates at the earliest opportunity.

It is often the case that only one, or a small number of isolated slates are damaged in an otherwise sound roof. It is therefore often necessary to replace or remove only a single or a small number of damaged slates without replacing, removing, or damaging overlying and underlying slates of adjacent rows of slates.

In some instances, it is also necessary to remove a single or small number of slates from a roof when a roof is being modified, for example to create an opening for the installation of flues, vents or windows. Again, this must achieved without removing or damaging adjacent overlying and underlying slates of adjacent rows of slates.

Removing a single or small number of slates from a roof is, however, a challenging task. As discussed above, each fixing used to hold a slate in place is typically covered and rendered inaccessible by overlying slates.

Therefore, in order to remove a single slate from a roof, it is necessary to cut or otherwise remove each fixing, which secures the slate to be removed to the underlying batten, without removing the overlying slates. This is achieved by sliding a tool under the slate to be removed to engage with each fixing, so that the fixing(s) can be cut or pulled free from the underlying batten.

Suitable tools for performing this task are known in the art and are commonly used by a roofer. Commonly, a tool known as a ‘slate ripper’ is used. An example of a known slate ripper is disclosed in United States published patent application US20060037199A1. The slate ripper comprises a narrow elongate ‘blade’ with hooks or slots at one end, and a handle at the other.

In use, the hooked end of the slate ripper is slid under the slate to be removed, and one of the hooks is engaged around a fixing which secures the slate to the underlying batten. A sharp and sudden force is then applied to the handle of the slate ripper, for example using a hammer. This breaks or rips the fixing from the underlying batten.

Once each fixing has been broken or removed using the slate ripper, the slate can be slid from between the overlying and underlying rows of slate(s).

This method for removing a slate carries a number of risks. Firstly, the force required to break or rip each fixing from the underlying batten is relatively large. The application of such force risks damaging adjacent slates, splitting the underlying batten, or damaging the tool itself.

Secondly, this method presents a risk of injury. The application of force to the handle of the slate ripper using, for example, a hammer, can cause a user to lose balance. This can result in serious injury when working at height. If a fixing suddenly breaks free, the hammer or slate ripper might also strike the user, causing injury.

Thirdly, the user generally requires additional tools (e.g. a hammer) to apply a force to the slate ripper. This increases the number of tools that must be carried onto the roof and leaves the user without a free hand to support the slate once each fixing has been broken or removed.

Finally, the use of a slate ripper provides an inconsistent method for removing a fixing. In some instances, the fixing is torn free from the underlying batten, while in others the fixing is merely sheared, leaving a portion of the fixing in place in the underlying batten. When a fixing is sheared, it deforms and breaks unevenly, leaving a bent and often sharp portion of the fixing in place. This deformed and sharp portion can obstruct the removal of the slate, as well as obstruct and damage a replacement slate as it is slid into position.

GB 2400579 A describes and shows a saw for roofing applications, in particular for removing modular roof components. The saw comprises a blade and a handle portion.

GB 2511203 A discloses a saw for cutting nails to remove roof tiles. The saw comprises a body portion having a blade.

GB 06963 A discloses a tool for cutting the heads of nails holding roof tiles. The tool comprises a blade having one or more cutting edges and means for limiting movement of the blade.

JP2003314014A discloses a tool for cutting roof nails.

A tool for cutting roof nails is also disclosed in JPH02213554A.

There therefore remains a need for an improved device and method for removing individual slates from a roof. Specifically there remains a need for a device which can be used in a reliable, safe, and reproducible method for cutting the fixing(s) which secure a slate to a roof.

Accordingly, a first aspect of the present invention provides a blade assembly for a tool for removing a slate from a roof, the blade assembly comprising:

a blade having a length, a width, and a plurality of teeth; and

a blade support, the blade being mounted to the blade support;

wherein the blade support extends over at least 30% of the width of the blade; and

wherein the thickness of the blade support to a first side of the blade is greater than the set of the teeth of the blade.

There is also provided a method for removing a slate from a roof using a blade assembly according to the present invention, the method comprising:
i) sliding the blade assembly beneath the slate to be removed such that the blade engages with a fixing which attaches the slate to the roof;
ii) moving the blade assembly in a reciprocating or ‘sawing’ motion such that the toothed blade cuts through the fixing; and
iii) removing the slate from the roof.

The blade assembly of the present invention, and associated methods of use, offer a number of advantages over prior art tools and methods for slate removal.

Firstly, each slate can be removed in a controlled manner. A user is only required to apply relatively small and consistent forces to the blade assembly to move the blade against the fixing in a sawing motion. This predictable and repetitive motion reduces the risk of accidental damage to adjacent slates. Cutting the fixing in this manner also prevents damage to the underlying batten. The application of a small and consistent force also reduces the risk of injury to the user when working at height.

Secondly, the user only requires the blade assembly of the present invention to remove a slate from a roof. Additional tools such as hammers are not required. The user can therefore keep one hand free to support the slate to be removed once a fixing has been cut.

Further, the blade assembly of the present invention prevents damage to the slates underlying the slate to be removed, as might be caused by a slate ripper or conventional saw, the teeth of which would scratch the surface of the underlying slate(s).

Finally, when a fixing is cut with the blade assembly according to the present invention, the surface of the cut lies flat and substantially flush with the surface of the underlying slate(s) or batten. This prevents obstruction from the remaining portion of the fixing when removing or replacing the slate.

The blade assembly of the present invention, comprises a blade. Suitable blade designs will be apparent to the person skilled in the art.

The blade is suitable for cutting, more specifically sawing, through a fixing retaining the slate in the roof. In particular, the blade is suitable for cutting a metal fixing, for example a metal fixing with a relatively small diameter, such as a hook or nail. The blade is therefore preferably a fine-toothed saw blade, for example a hacksaw blade.

The blade may have at least 10 teeth per inch, more preferably at least 15 teeth per inch, more preferably still at least 20 teeth per inch. In one preferred embodiment, the blade has 24 teeth per inch.

The blade may be formed from any suitable material. The blade is preferably formed from carbon steel or low tungsten steel. The blade is most preferably a bimetal hacksaw blade. As will be appreciated by a person skilled in the art, a variety of hacksaw blades are commercially available having standardised dimensions. In a preferred embodiment, the blade support is arranged to support a standardised commercially available blade, as described in more detail below.

As noted above, the blade assembly further comprises a blade support. The blade is mounted to the blade support and is supported by the blade support. The blade support may be formed from any suitable material to support the blade. The blade support is preferably formed from metal, more preferably steel, such as spring steel. However, as will be appreciated by a person skilled it the art, the blade support may be formed from any suitable material, including but not limited to other metals, woods, and plastics.

The blade is mounted to and held by the blade support during use of the blade assembly. Preferably, in the blade assembly according to the present invention, the blade is releasably mounted to the blade support. This can be achieved using double-sided adhesive tape. As will be appreciated by a person skilled in the art, other mounting means, including releasable mounting means may be used. For example, the blade may be mounted to the blade support using an adhesive. Alternatively, the blade may be mounted to the blade support using fastenings such as pins, rivets, or clips. Other mounting solutions, such as welding, are also contemplated, for example in embodiments where the blade is permanently mounted to the blade support.

Although the blade may be permanently mounted to the blade support, it is preferred that the blade is detachably mounted, as noted above. This is advantageous as it allows a user to replace the blade when it becomes worn. In this respect, the blade may be a consumable part.

The blade assembly is arranged such that, with the blade mounted to the blade support, the blade support extends over, so as to cover, at least 30% of the width of the blade. This has a number of advantages.

Firstly, the blade support fulfils a structural role. Saw blades, for example hacksaw blades, typically require additional support to prevent the blade from flexing during use. Generally, as is known in the art, support is provided by a frame. The frame often takes the form of a rigid curved bar. The blade is tensioned and affixed at either end to the curved bar to provide stiffness and support. However, it is not possible to use such frames in environments where space is limited, in particular between slates in a roof. Saws including such frames are therefore not suitable for sliding between the slates on a roof.

The blade support of the present invention therefore provides rigidity to prevent the blade from bending or flexing during use, while being thin enough so that the blade assembly can slide between the slates of a roof.

Additionally, the blade support is designed to contact with a surface of an underlying slate during use. The blade support therefore spaces and prevents the cutting edge of the saw blade from contacting the underlying slate or surface during use. This not only prevents excessive wear to the blade, but also prevents the underlying slate(s) from being scratched or gouged by the blade. To this end, when the blade assembly is slid between the slates of a roof, the blade support preferably lies generally flat against the underlying slate(s).

The blade support extends over and covers at least 30% of the width of the blade. The extent of the blade support over at least 30% of the width of the blade is sufficient to prevent the portion of the blade extending beyond the edge of the blade support from flexing or tilting in use towards the underlying slate(s), thereby preventing the teeth of the blade damaging the surface of the underlying slate(s).

More preferably, the blade support extends over at least 40% of the width of the blade, more preferably still at least 50%, still more preferably at least 70%, still more preferably at least 75%. In one preferred embodiment, the blade support extends over about 40 to 90% of the width of the blade, preferably from 50 to 85%, more preferably from 60 to 80%, still more preferably from 65 to 75% of the width of the blade.

The thickness of the blade support to a first side of the blade is greater than the set of the teeth of the blade. The ‘set’ of a saw blade is the maximum distance to which the teeth of the cutting edge are bent outwards and away from either side of the surface of the blade. Saw blades are set to ensure the cutting edge is wider than the thickness of the blade immediately behind, that is adjacent, the teeth. This prevents the blade from binding during use.

However, the set of the teeth of the blade also means that the teeth at the cutting edge protrude from the flat face of either side of the blade. Therefore the thickness of the blade support must be sufficient to prevent any teeth which protrude towards the underlying slate(s), in use, from contacting the underlying slate(s). Again, this prevents excessive wear to the blade, and damage to the underlying slate(s).

The blade may have a set of zero. That is to say, the teeth of the blade may be in line and the same thickness as the rest of the blade. More preferably, the teeth of the blade have a set greater than zero, in particular to prevent the blade from binding when cutting the fixing.

The blade support may be shorter in length than the blade. In such embodiments, the blade support should extend along a sufficient portion of the length of the blade to prevent the teeth of the blade contacting the surface of an underlying slate, in normal use. Preferably, the blade support extends at least the full length of the blade. More preferably the blade support is longer than the blade. Most preferably, the blade support and the blade are arranged such that the blade support extends beyond both ends of the blade.

The blade support may include a recess, the blade being located in and extending from the recess. The recess in the blade support may help to locate the blade in the correct position when the blade is mounted to the blade support.

In one embodiment according to the first aspect of the present invention, the blade assembly preferably comprises:

a blade holder, the blade holder having a recess, the blade located in and extending from the recess;

wherein the blade holder is mounted to the blade support.

The blade holder has a recess for receiving the blade. The recess is located at an edge of the blade holder. In use, the blade is located in, and extends from, the recess, with the teeth of the blade exposed. The recess in the blade holder helps to locate the blade in the correct position relative the blade support. The blade holder also provides additional support and reinforcement to the blade assembly.

It is preferred that the blade holder has the same thickness as the portion of the blade located in the recess, so that the surface of the blade holder lies flush with the surface of the blade located in the recess.

The blade holder may be formed from any suitable material. The blade holder is preferably formed from metal, such as steel, in particular spring steel. However, as will be appreciated by a person skilled it the art, the blade holder may be formed from any suitable material, including other metals, woods, and plastics.

The blade holder may be mounted to the blade support in any suitable manner. The blade holder is preferably releasably mounted to the blade support. The blade holder may be mounted to the blade support in a similar manner to the blade. For example, the blade holder may be mounted to the blade support using double-sided adhesive tape or an adhesive. Alternatively, the blade holder may be mounted to the blade support using fastenings such as pins, rivets, or clips. Other mounting solutions, such as welding, are also contemplated.

In a further embodiment according to the first aspect of the present invention, the blade support preferably comprises:

a first blade support member extending over the first side of the blade; and

a second blade support member extending over a second side of the blade;

wherein the thickness of both the first blade support member and the second blade support member is greater than the set of the teeth of the blade.

In this manner, the blade and the blade holder, if present, are located between and mounted to the first and second blade support members of the blade support. The blade and blade holder, if present, are mounted to the first and second blade support members of the blade support using any suitable means, as described above.

The first and second blade support members each extend over at least 30% of the width of the blade. As will be readily appreciated from the above discussion, the first and second blade support members ensure the cutting edge of the blade is unable to bend or flex to contact with the underlying slate(s).

The thickness of both the first blade support member and the second blade support member is greater than the set of the teeth of the blade. Again, as will be readily appreciated from the above discussion, this ensures the cutting edge of the blade is unable to contact with the underlying slate(s) and the underside of the slate to be replaced when the blade assembly is slide between the slates of a roof.

Although it is advantageous for the blade support to extend over at least 30% of the blade, it is important that a sufficient portion of the width of the blade remains exposed. In particular, the width of the exposed portion of the blade must be greater than the diameter of a fixing to be cut. Otherwise, the edge of the blade support will contact and abut against the fixing during cutting, thus preventing the blade from cutting the whole way through the fixing.

Fixings, such as hooks and nails, used to secure a slate to a roof are typically around 3 mm in diameter. Thus, in a preferred embodiment the cutting edge of the blade extends beyond an edge of the blade support by at least 3.5 mm, preferably at least 4 mm. In some embodiments the cutting edge of the blade may extend beyond an edge of the blade support by larger or smaller amounts, depending on the diameter of the fixing to be cut. For example, the cutting edge of the blade may extend beyond an edge of the blade support by at least 1 mm. In some embodiments the cutting edge of the blade may extend beyond an edge of the blade support by up to 10 mm.

The first and/or second blade support member may include a recess, the blade being located in and extending from the recess. In one embodiment, both the first and second blade support members comprise a recess, with the recesses opposing one another and accommodating the blade. The recess in the first and/or second blade support member may help to locate the blade in the correct position when the blade is mounted to the blade support. In embodiments where the first and/or second blade support member includes a recess, it may not necessary to include an additional blade holder. However, in one embodiment, each of a blade holder, first blade support member and second blade support member may include a recess.

In a further embodiment, the first and second blade support members and the blade holder, if present, may be formed as a single integral component. In this respect, the blade may be mounted in a recess in the integrally formed first and second blade support members and/or the blade holder, if present. The blade may be mounted in the recess by any suitable attachment means, including but not limited to pins, bolts, rivets, clips, adhesives and adhesive tapes, as discussed above.

In one embodiment, the first and second blade support members and the blade holder, if present, may be formed around the blade during manufacture. For example, the first and second blade support members and the blade holder, if present, may be formed around the blade as a single integral component by overmolding. In such embodiments, the blade support and blade holder, if present, are preferably formed from a plastic.

In a further aspect, the present invention provides a blade assembly for a tool for removing a slate from a roof, the blade assembly comprising:

a blade having a length, a width, and a plurality of teeth; and

a blade support;

wherein the blade support extends over a sufficient portion of a first side of the blade such that, in use, the teeth of the blade are prevented from coming into contact with a slate adjacent the first side of the blade assembly.

In a further aspect of the present invention, there is provided a saw comprising:

a handle; and

a blade assembly as hereinbefore described.

The saw of this aspect of the invention comprises a handle. Preferably, the handle is connected to the blade support of the blade assembly. As will be readily appreciated by the skilled person, the handle can take any suitable form. A variety of suitable saw handles are known in the prior art, including both open and closed pistol grip and straight handles. In the interests of conciseness, further discussion of the form of the handle is omitted.

The blade assembly may be fixed to the handle using any suitable means, including but not limited to pins, bolts, rivets, adhesives and over moulding.

Embodiments of the present invention will now be described by way of example only, having reference to the accompanying drawings, in which:

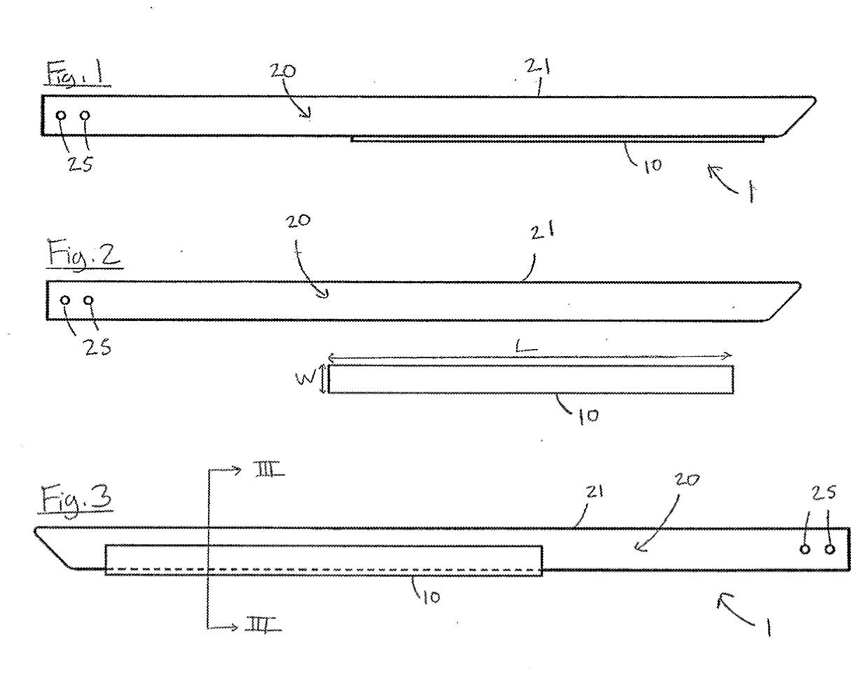

FIG. 1 is an obverse view of a blade assembly according to a first embodiment of the present invention;

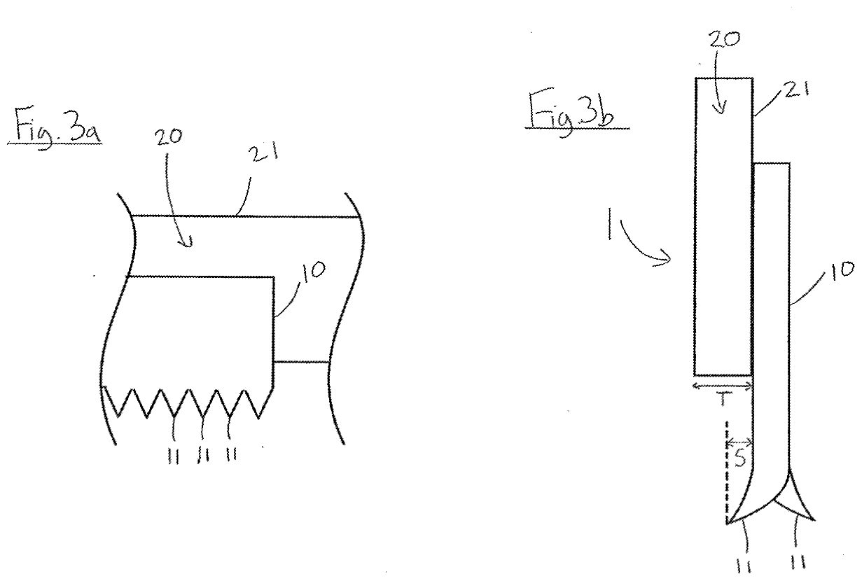

FIG. 2 illustrates components of the blade assembly of FIG. 1 in more detail;

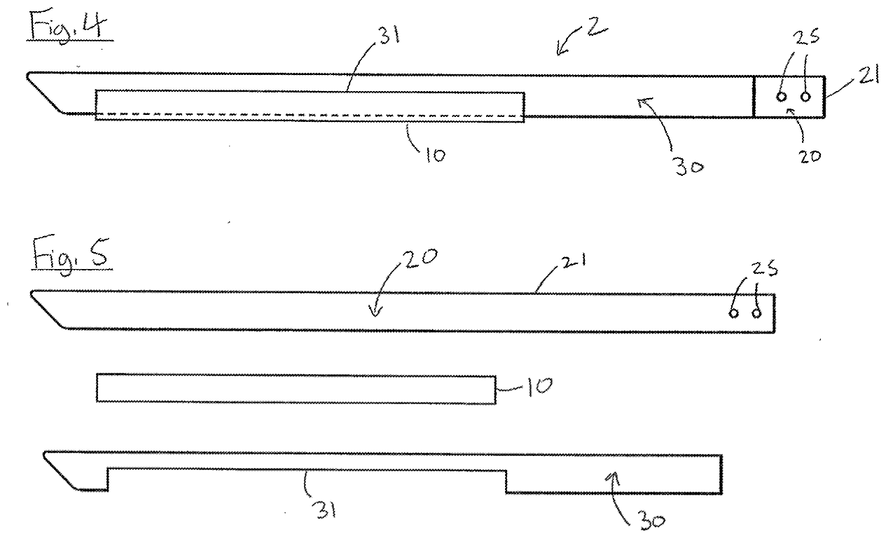

FIG. 3 is a reverse view of the blade assembly of FIG. 1;

FIG. 3a is an enlarged view of a portion of the blade and blade support of the blade assembly of FIG. 3, showing the teeth of the blade;

FIG. 3b is a cross-sectional view of the blade assembly of FIG. 3 along the line III-III;

FIG. 4 is a reverse view of a blade assembly according to a second embodiment of the present invention;

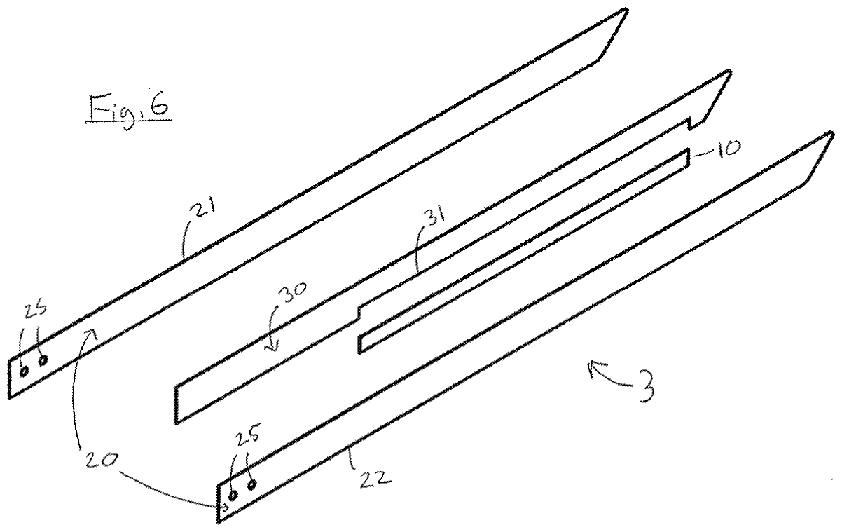

FIG. 5 illustrates components of the blade assembly of FIG. 4 in more detail;

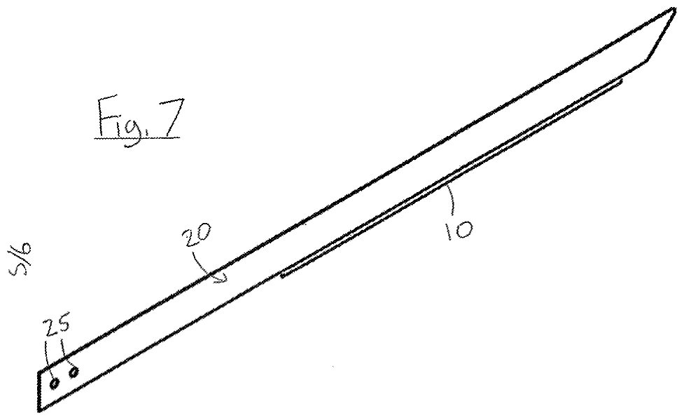

FIG. 6 is an exploded view of a blade assembly according to a third embodiment of the present invention;

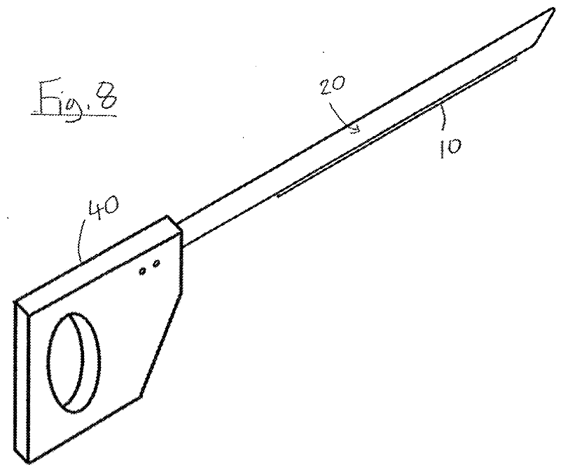

FIG. 7 is a perspective view of a blade assembly according to embodiments of the present invention; and

FIG. 8 is a perspective view of a saw including a blade assembly according to embodiments of the present invention.

For ease of explanation, like numbers have been used throughout the Figures to indicate analogous features of each embodiment.

Turning now to FIG. 1, there is shown an obverse view of a blade assembly, indicated generally as 1, according to a first embodiment of the present invention. The blade assembly 1 includes a blade 10 and a blade support 20 formed from a first blade support member 21. Two holes 25 are formed in the blade support to allow for attachment of a handle, as will be described in more detail below.

The blade 10 is mounted to and supported by the first blade support member 21 of the blade support 20. The blade may be mounted to the first blade support member by any suitable attachment means. Preferably, the blade is mounted to the blade support using a layer of double-sided adhesive tape.

As illustrated in FIG. 2, the blade 10 has a length L and a width W. When the blade is mounted on the blade support 20, the first blade support member 21 extends over at least 30% of the width of the blade. This can be seen more clearly in FIG. 3, which shows a reverse view of the blade assembly 1 according to a first embodiment of the present invention with the blade 10 mounted to the blade support 20. It can be seen from FIG. 3, that the first blade support member 21 of the blade support extends over the major portion of the width of the blade, preferably at least 75% of the width of the blade.

The blade 10 has a plurality of teeth 11, shown in more detail in FIG. 3a.

As can be seen in FIG. 3b, the thickness T of the first blade support member 21 is greater than the set S of the teeth 11 of the blade 10.

Turning now to FIG. 4, there is shown a reverse view of a second embodiment of a blade assembly according to the present invention, indicated generally as 2. As in the first embodiment shown in FIGS. 1 to 3, the second embodiment includes a blade 10 mounted to a blade support 20 formed from a first blade support member 21. It is to be understood that the features of the blade and blade support of the second embodiment are analogous to those of the first embodiment and, in the interests of conciseness, further discussion of these components is omitted.

The second embodiment illustrated in FIG. 4 further includes a blade holder 30 mounted to the blade support 20. The blade holder is illustrated more clearly in FIG. 5. The blade holder includes a recess 31. The blade 10 is located in the recess when the blade and blade holder are mounted to the blade support. As shown in FIG. 4, the teeth of the blade lie outside the recess 31.

The blade holder may be mounted to the first blade support member by any suitable attachment means. Preferably, the blade holder is mounted to the blade support using a double-sided adhesive tape.

Turning now to FIG. 6, there is shown an exploded view of a blade assembly according to a third embodiment of the present invention. As in the second embodiment shown in FIGS. 4 and 5, the third embodiment includes a blade 10, and a blade holder 30 mounted to a first blade support member 21 of a blade support 20. It is to be understood that the features of the blade, blade holder and first blade support member of the third embodiment are analogous to those of the second embodiment and, in the interests of conciseness, further discussion of these components is omitted.

In the third embodiment, the blade support 20 further includes a second blade support member 22. The second blade support member is similar to the first blade support member. The blade 10 and blade holder 30 are mounted to the second blade support member. Preferably, the blade and blade holder are mounted to the second blade support member using a double-sided adhesive tape.

The blade 10 and blade holder 30 are therefore mounted to each of the first and second blade support members 21, 22 such that, in the blade assembly 3 of the third embodiment, the blade and the blade holder are located between the first and second blade support members. The blade 10 extends beyond the adjacent edges of the first and second blade support members, such that the teeth of the blade lie outside of the blade support members 21, 22 and the blade holder 30.

In an alternative embodiment, the blade holder may be omitted, so that the blade assembly comprises only a blade 10 mounted to a first and second blade support member 21, 22 of the blade support.

The thickness of each of the first and second blade support members 21, 22 is greater than the set of the teeth of the blade 10.

In FIG. 7, there is shown a further perspective view of a blade assembly according to the first, second and third embodiments of the present invention.

The blade assembly according to embodiments of the present invention is preferably included in a saw. As shown in FIG. 8, the blade assembly may be affixed to a handle 40 to form a saw. The handle shown in FIG. 8 is a closed pistol grip handle.

1. A blade assembly for a tool for removing a slate from a roof, the blade assembly comprising:
a blade having a length, a width, and a plurality of teeth; and
a blade support, the blade being mounted to the blade support;
wherein the blade support extends over at least 30% of the width of the blade; and
wherein the thickness of the blade support to a first side of the blade is greater than the set of the teeth of the blade.

2. The blade assembly according to claim 1, wherein the blade support extends over at least 40% of the width of the blade, preferably at least 50%, more preferably at least 70%, still more preferably at least 75%.

3. The blade assembly according to claim 1, wherein the blade assembly further comprises:
a blade holder, the blade holder having a recess, the blade located in and extending from the recess;
wherein the blade holder is mounted to the blade support.

4. The blade assembly according to claim 1, wherein the blade support comprises:
a first blade support member extending over the first side of the blade; and
a second blade support member extending over a second side of the blade;
wherein the thickness of both the first blade support member and the second blade support member is greater than the set of the teeth of the blade.

5. The blade assembly according to claim 1, wherein the blade support extends at least the full length of the blade.

6. A blade assembly for a tool for removing a slate from a roof, the blade assembly comprising:
a blade having a length, a width, and a plurality of teeth; and
a blade support;
wherein the blade support extends over a sufficient portion of a first side of the blade such that, in use, the teeth of the blade are prevented from coming into contact with a slate adjacent the first side of the blade assembly.

7. A saw comprising:
a handle; and
a blade assembly according to claim 1.

8. The saw according to claim 7, wherein the handle is connected to the blade support of the blade assembly.
